(19) United States
(12) Patent Application Publication
(10) Pub. No.: US 2008/0121221 A1
(43) Pub. Date: May 29, 2008

(54) Barbecue with grease pan

(76) Inventors: Bu-Jiunn Wang, Taiping City (TW); Ming-Jann Chang, Taiping City (TW); Shuh-Huei Liou, Dali City (TW)

Correspondence Address: PRO-TECHTOR INTERNATIONAL SERVICES, 20775 NORADA CT., SARATOGA, CA, 95070, US

(21) Appl. No.: 11/588,509

(22) Filed: Oct. 27, 2006

(51) Int. Cl. A47J 37/00

(52) U.S. Cl. 126/25 R

(57) ABSTRACT

A barbecue in one embodiment includes a rectangular firepot including four legs extended downward from its four bottom corners, a rectangular top plate on either side, a first space at either side of the firepot for containing fuel, a second space confined between the first spaces and having a V-shaped bottom, and a grease pan under the bottom and being in fluid communication with the second space; and a rectangular grate fitted on a top of the second space and disposed between the plates. In use foodstuffs are placed on the grate such that burning the fuel will cook the foodstuffs with grease dropped from the foodstuffs on the bottom and flowed into the grease pan for collection. Generated smoke is decreased to a minimum because the grease drops do not fall on the burning fuel.

### BACKGROUND OF THE INVENTION

1. Field of Invention

The present invention relates to barbecues and more particularly to such a barbecue having a grease pan for collecting grease drops falling from the foodstuffs while cooking food.

2. Related Art

A conventional barbecue is shown in FIGS. 1 and 2 and comprises a rectangular firepot 10, four legs 12 extended downward from four bottom corners of the firepot 10 for supporting and raising the firepot 10 a distance above the ground, a peripheral flange 13 on a top edge of the firepot 10, and a rectangular grate 11 fitted on the flange 13. In use, fuel (e.g., charcoal or the like) 20 is first placed in the firepot 21 and burned. Next, foodstuffs 21 such as meat, fish, or the like are placed on the grate 11 and are smoked, dried, or broiled thereafter by heat generated by the burning fuel 20.

However, a substantial amount of smoke may generate while barbecuing. This is because grease drops fall from the foodstuffs 21 being cooked on the fuel 20 and then are burned on the fuel 20. Thus, a need for a means to collect falling grease drops while barbecuing exists.

### SUMMARY OF THE INVENTION

It is therefore an object of the present invention to provide a barbecue having a device to collect grease drops falling from foodstuffs while cooking food.

In one aspect of the present invention there is provided a barbecue comprising a rectangular firepot including four legs extended downward from its four bottom corners, a rectangular top plate on either side, a first space at either side of the firepot for containing fuel, a second space confined between the first spaces and having a V-shaped bottom, and a grease pan under the bottom and being in fluid communication with the second space; and a rectangular grate fitted on a top of the second space and disposed between the plates, wherein in a use foodstuffs are placed on the grate such that burning the fuel will cook the foodstuffs with grease dropped from the foodstuffs on the bottom and flowed into the grease pan for collection.

In another aspect of the present invention there is provided a barbecue comprising a circular firepot including three equally spaced legs extended downward from its bottom, an annular, inwardly extending plate on a top edge, a peripheral first space for containing fuel, a central second space confined by the first space and having a V-shaped bottom, and a grease pan under the bottom and being in fluid communication therewith; and a circular grate fitted on a top of the second space and confined by the plate, wherein in a use foodstuffs are placed on the grate such that burning the fuel will cook the foodstuffs with grease dropped from the foodstuffs on the bottom and flowed into the grease pan for collection.

The above and other objects, features and advantages of the present invention will become apparent from the following detailed description taken with the accompanying drawings.

### BRIEF DESCRIPTION OF THE DRAWINGS

FIG. 1 is an exploded perspective view of a conventional barbecue;

FIG. 2 is a longitudinal cross-sectional view of the assembled barbecue in FIG. 1 with foodstuffs placed on the grate and fuel burned therein;

FIG. 3 is an exploded perspective view of a first preferred embodiment of barbecue according to the present invention;

FIG. 4 is a longitudinal cross-sectional view of the assembled barbecue in FIG. 3;

FIG. 5 is a transverse cross-sectional view of the assembled barbecue in FIG. 3;

FIG. 6 is a longitudinal cross-sectional view of the assembled barbecue in FIG. 3 with foodstuffs placed on the grate and fuel burned therein;

FIG. 7 is a perspective view of the assembled barbecue in FIG. 3 where another way of cooking foodstuffs and warming dinnerware is shown;

FIG. 8 is an exploded perspective view of a second preferred embodiment of barbecue according to the present invention;

FIG. 9 is a cross-sectional view of FIG. 8; and

FIG. 10 is a cross-sectional view of FIG. 8 with foodstuffs placed on the grate and fuel burned therein.

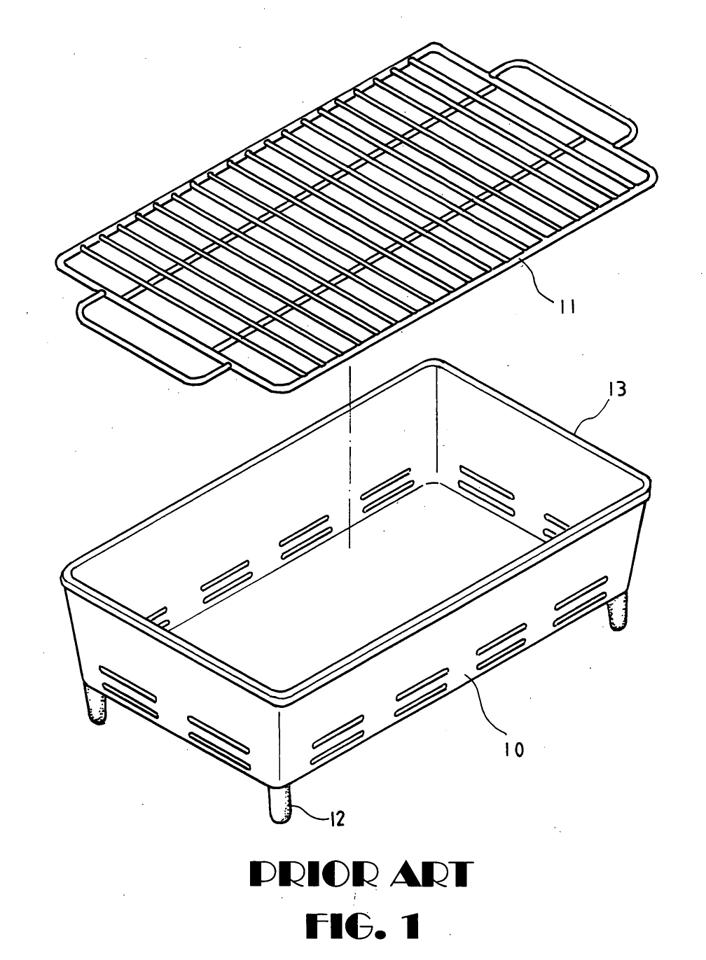

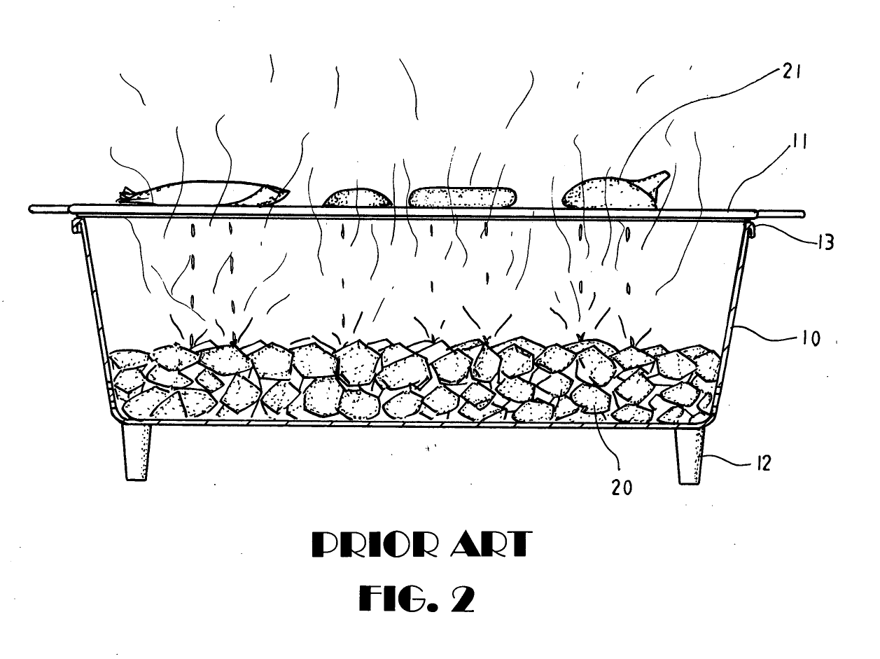

### DETAILED DESCRIPTION OF THE INVENTION

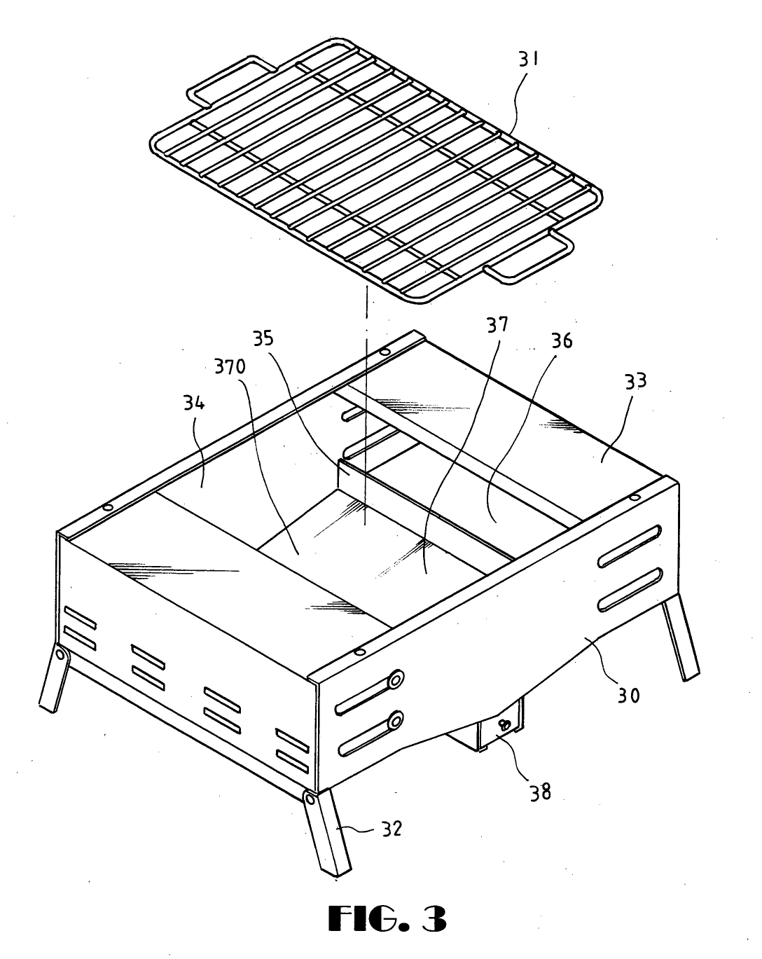

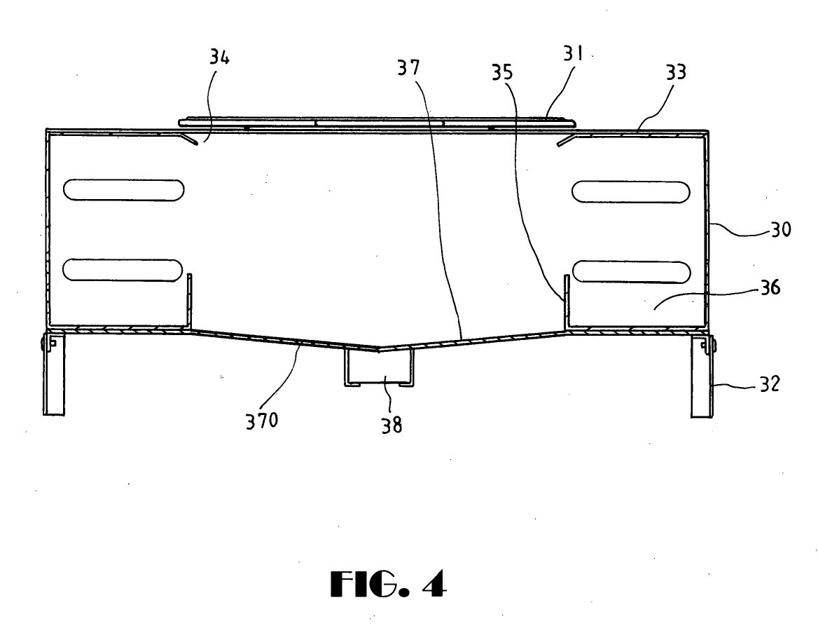

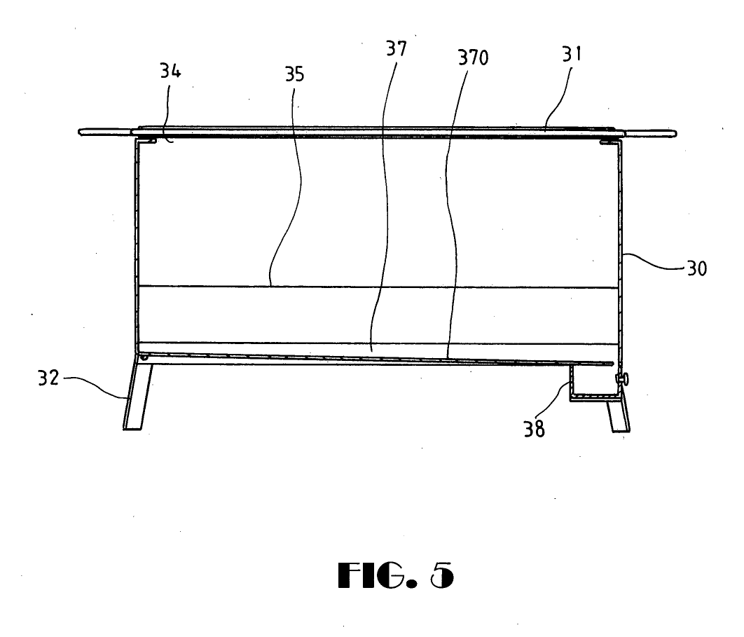

Referring to FIGS. 3 to 7, a barbecue in accordance with a first preferred embodiment of the present invention is shown. The barbecue comprises a rectangular firepot 30, four legs 32 extended downward from four bottom corners of the firepot 30 for supporting and raising the firepot 30 a distance above the ground, a rectangular top plate 33 on either side of the firepot 30, a first space 36 at either side of the firepot 30, a second space 37 confined between the first spaces 36, a top opening 34 in communication with the second space 37 and the external, the second space 37 having two downwardly inclined bottom surfaces 370 joined at a transverse, central line (i.e., the bottom of the second space 37 having a V-shaped section), two transverse walls 35 each for dividing the first space 36 from the second space 37, a grease pan 38 under the joined line of the surfaces 370 and being in fluid communication with the second space 37 via one or more openings (not shown) therebetween, and a rectangular grate 31 fitted on the opening 34 and disposed between the plates 33.

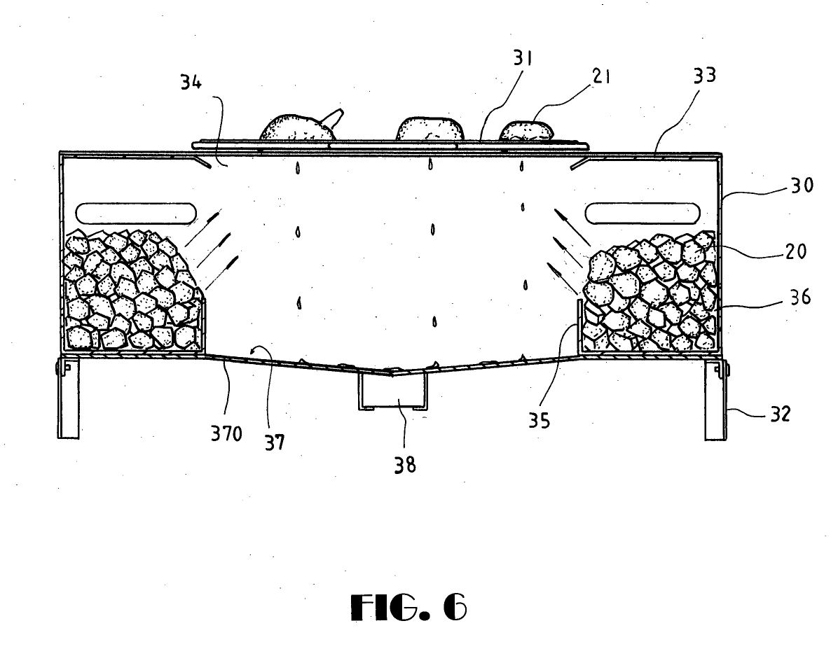

As shown in FIG. 6 specifically, in one use foodstuffs 21 are placed on the grate 31. Also, fuel (e.g., charcoal or the like) 20 is placed in the first spaces 36 and burned for smoking, drying, or broiling the foodstuffs 21. Grease drops fall from the foodstuffs 21 on the surfaces 370. Finally, the grease drops flow into the grease pan 38 from the surfaces 370 for collection. By configuring above, generated smoke is decreased to a minimum while barbecuing because the grease drops do not fall on the burning fuel 20.

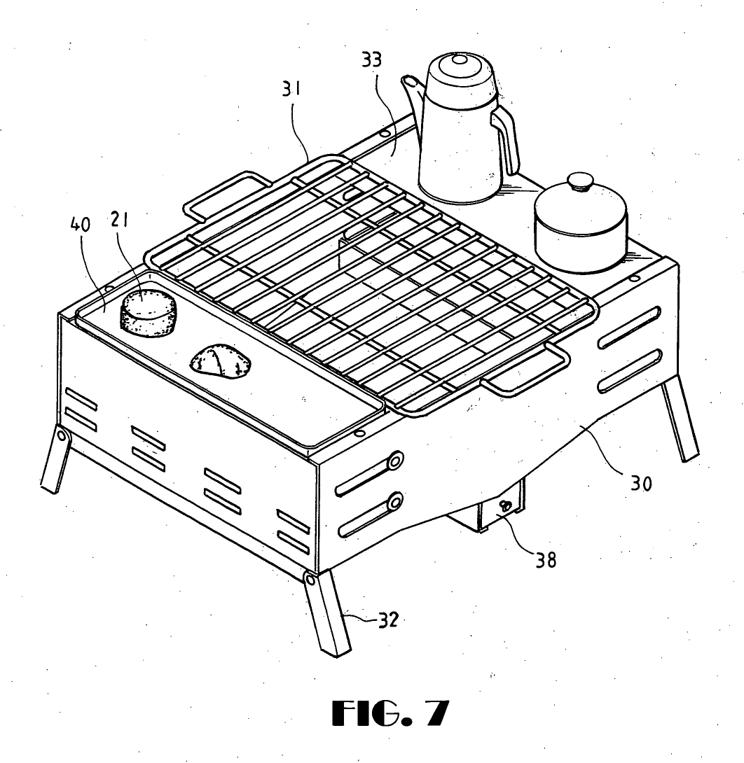

As shown in FIG. 7 specifically, in another use the foodstuffs 21 are placed on a pan 40 located on one plate 33 and two pieces of dinnerware are placed on the other plate 33. In this use, the foodstuffs 21 are cooked with generated grease contained in the pan 40 and the pieces of dinnerware are warmed as the fuel burning.

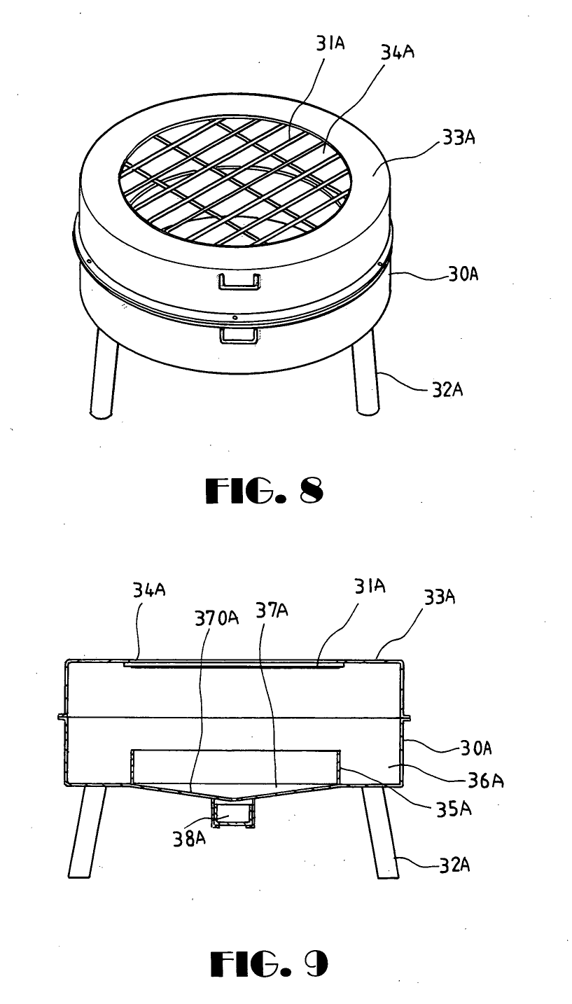

Referring to FIGS. 8 to 10, a barbecue in accordance with a second preferred embodiment of the present invention is shown. The barbecue comprises a circular firepot 30A, three equally spaced legs 32A extended downward from a bottom of the firepot 30A for supporting and raising the firepot 30A a distance above the ground, an annular, inwardly extending plate 33A on a top edge of the firepot 30A, a first space 36A around a periphery of the firepot 30A, a central second space 37A having a top opening 34A in communication with the external, the second space 37A having a tapered bottom 370A, a circular wall 35A for dividing the first space 36A from the second space 37A, a grease pan 38A under the second space 37A and being in fluid communication therewith via one or more openings (not shown) therebetween, and a circular grate 31A fitted on the opening 34A and confined by the plate 33A.

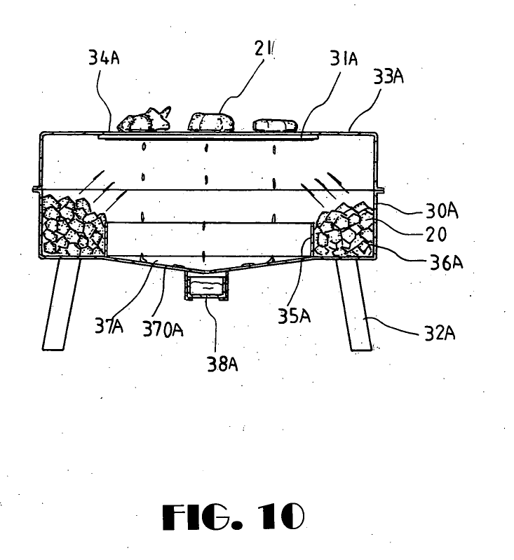

As shown in FIG. 10 specifically, in use foodstuffs 21 are placed on the grate 31A. Also, fuel (e.g., charcoal or the like) 20 is placed in the first space 36A and burned for smoking, drying, or broiling the foodstuffs 21. Grease drops fall from the foodstuffs 21 on the bottom 370A of the second space 37A. Finally, the grease drops flow into the grease pan 38A from the bottom 370A for collection. By configuring above, generated smoke is also decreased to a minimum while barbecuing because the grease drops do not fall on the burning fuel 20.

The present invention has been shown and described in detail, various modifications and improvements thereof will become readily apparent to those skilled in the art. Accordingly, the spirit and scope of the present invention is to be construed broadly and limited only by the appended claims and not by the foregoing specification.

What is claimed is:

1. A barbecue comprising:
a rectangular firepot including a rectangular top plate on either side, a first space at either side of the firepot for containing fuel, a second space confined between the first spaces and having a V-shaped bottom, and a grease pan under the bottom and being in fluid communication with the second space; and
a rectangular grate fitted on a top of the second space and disposed between the plates,
wherein in a first use foodstuffs are placed on the grate such that burning the fuel will cook the foodstuffs with grease dropped from the foodstuffs on the bottom and flowed into the grease pan for collection.

2. The barbecue of claim 1, further comprising a pan adapted to place on one plate, and wherein in a second use grease generated by the foodstuffs in the pan is contained therein while cooking the foodstuffs.

3. The barbecue of claim 1, wherein the firepot further comprises four legs extended downward from its four bottom corners.

4. A barbecue comprising:
a circular firepot including an annular, inwardly extending plate on a top edge, a peripheral first space for containing fuel, a central second space confined by the first space and having a V-shaped bottom, and a grease pan under the bottom and being in fluid communication therewith; and
a circular grate fitted on a top of the second space and confined by the plate,
wherein in a first use foodstuffs are placed on the grate such that burning the fuel will cook the foodstuffs with grease dropped from the foodstuffs on the bottom and flowed into the grease pan for collection.

5. The barbecue of claim 4, wherein the firepot further comprises three equally spaced legs extended downward from its bottom.
